(19) United States
(12) Patent Application Publication
(10) Pub. No.: US 2024/0044667 A1
(43) Pub. Date: Feb. 8, 2024

(54) AUTOMATED DATA COLLECTION ARCHITECTURE FOR USE IN VEHICLE OPERATIONS

(71) Applicant: Rydeen North America, Inc., Torrance, CA (US)

(72) Inventor: Philip Maeda, Torrance, CA (US)

(73) Assignee: Rydeen North America, Inc., Torrance, CA (US)

(21) Appl. No.: 18/382,808

(22) Filed: Oct. 23, 2023

Related U.S. Application Data
(63) Continuation of application No. 17/337,228, filed on Jun. 2, 2021.

(51) Int. Cl. G01C 21/00; G06F 21/64

(52) U.S. Cl. CPC G01C 21/3807; G01C 21/3841; G06F 21/64

(57) ABSTRACT

A system for acquiring data from vehicle in real time for mapping infrastructure using blockchain technology.

### BACKGROUND OF THE INVENTION

### 1. Field of the Invention

The present invention relates to real-time geographical data collected and processed by countless users contributing image and location information to a computing platform using blockchain technology that can be accessed for a nearly real-time view of a given area or region. The data collected from the users or the data management systems can be collected from vehicle-based sensor systems including but not limited to, visual cameras including stereo and 360-degree cameras, GPS, terrain-based sensors, audio capturing via microphones, high-frequency (micro or milli-waves) radars, high-speed laser scanning systems such as LIDAR (Light Detection and Ranging) systems. These systems offer enhanced images and associated modeling capturing the environmental data in three-dimensional imaging surrounding a vehicle with location, speed, and various visual perspectives. The captured location-based information including geographical digital mapping, (thereafter called data) can be stored locally within a vehicle and transmitted via radio frequency over available networks such as Wi-Fi or cellular networks. Unlike vehicles send out on a yearly or multiyear basis that can map and capture images and data of an area of a region, this system would be updated daily (if not hourly) from the stream of information of every trip made by users in every area and would be extremely accurate indicating changes that could wear daily. New construction and changes in routes, streets, buildings, bridges as well as road abstraction can all be captured as assembled data. The data collected will be of an open architecture that can be used by contributors, companies, law enforcement, city, state, and county governments as well as autonomous vehicle companies that rely on “real, current” data for safer vehicle operation. The system will query member's or contributor's vehicle data including images from a vehicle-mounted camera as well as a 360-degree camera located within the vehicle. This can be done every time the vehicle is in use. The real-time images of the entire surroundings and a different angle give a complex view of the route traveled. The system is GPS and cellular system triangulation enabled so that each segment of the video will have an exact location that can be merged with another's video of the same location, further enhancing or building a substantially perfect image of the surrounding area. A secured storage service or cloud service will serve as a storage and assembly point for all of the data collected and will constantly build a living image in three-dimensions providing more and more clarity as the data matures. The system will rely on Blockchain technology for the accuracy and anonymity of contributors and participants.

### 2. Description of the Prior Art

Presently, there are many individuals, organizations including municipal governments, digital mapping companies and car manufacturers that collect digital imagery of streets for convenience to internet users, taxies, buses, police vehicles are on the roads every day, (with or without data-collecting device). Google® cars, for example, have driven most everyroad of the whole world.

For several years large data companies have been compiling data on everything present in each area or region. This data is compiled with cameras, LIDAR, and radar devices that are coupled with GPS and include satellite imagery to try and portray a view of the environment. This data collected contains roadways, buildings, natural habitat as well as bridges, tunnels, and all types of infrastructure. In one example, Google® uses a fleet of vehicles that drive roads and highways using all the data collection instruments listed above to obtain a mathematical, digital photographic representation of the entire area the vehicle travels. When coupled with GPS an accurate model of any city or area where the vehicles are deployed can be collected. This data can be used for many purposes which includes community planning, assistance for emergency services, real estate, commercial ventures, and political boundaries. The complete data collected can be utilized for these and thousands of other applications that rely on data from the selected target areas they wish to analyze. The problem with these types of data collection systems is that it is very hard to overcome with a dedicated small fleet of mapping or data collection vehicles since they are only accurate for a small period of time. However, roads can change, new developments and streets created, older infrastructure redesigned and new items built during short time periods. Thus, data collected can become stale or outdated very quickly.

While the current ability of interactive data hosting and mapping systems are impressive, they can be still slow, inaccurate, expensive to maintain, and contain inappropriate measures for user's privacy. Presently, the data collection is limited to specially equipped vehicles (such as the so-called “Google® Car”), driving every street around the world taking video imaginary, geographical location to creating data (plotting of digital maps and associated 3D imaginary). The interactive maps are generally generated by teams who take out specially equipped vehicles to chart areas and update the data. This is costly time-consuming as it is an ever-ongoing process. Realistically, only huge companies (like Google®) can offer these services, as they have the capital to update the data.

This type of system has many flaws and drawbacks. The “Google® Car” model is not real-time; the images may have been taken months if not years prior. Many things could have changed thereafter, i.e. road construction that can force the vehicle to detour, fallen trees or rocks, and infrastructure changes. It is also noted that with a “Google® Car” setup there is no imagery of parking structures, underground garages, parking facilities as the GPS is blocked by these structures and solid data cannot be achieved. What is desired is to provides vehicle data management system that overcomes the above-noted disadvantages.

In another example, the company Waze® uses GPS data from thousands of users to determine routing and traffic flow information. The data is captured in real-time and the speed and position of the vehicles participating are calculated to formulate the traffic flow in a given area. If that data shows these data points are moving very slowly on a road or highway with significantly high speeds, it can be determined that there is an issue that is preventing the vehicles from moving at optimal or full speed. This could mean an accident has occurred or something is impeding the roadway. This in principle uses real-time location data to solve the issue of state data. The Waze® platform does not record or preserve any other data that could be useful in other applications. The data points that are collected would be limited to, where, when, and speed of moving vehicles. No geographical data could be obtained by these types of systems.

Currently, dash and security-related cameras or data capturing devices have been available and installed in vehicles for several years. They are used to document driving conditions and conditions when the vehicle is parked. They are used primarily for the visual documentation of accidents that may occur while driving.

Lifestyle cameras have also been used such as helmet cameras, for recording lifetime moments, sporting events, and recording scenery. They are viewed and shared with friends or on social media.

In recent years, aiming for operating autonomous vehicles, various sensors have been developed or are in development, including visual cameras (single, stereo, and 360-degree cameras), ultrasonic sensors, high-frequency (micro or milli-waves) radars so-called blind-spot sensors (BSDs), and high-speed laser scanning system such as LIDAR for sensing the presence of objects surrounding a vehicle. These systems offer enhanced image capturing together with GPS and vehicle speed sensors for location information. There is currently no common platform for collecting data captured by commercially available sensors placed within vehicles.

These pre-installed system are all limited in their operation by multiple factors. The first of these factors is limited storage space for the recording of data captured from the vehicle's surroundings; typically, this data is used for driving a vehicle safely with or without human involvement. However, images, sound, motion, location, and surrounding digital data captured could be valuable for other vehicle operators, especially those following the same path or in the vicinity of the vehicle collected data at a prior time. Data storage capacity has always been an issue even with larger memory cards or hard discs that may be used within a vehicle. With the use of high-definition imaging cameras and high frame rates, the file sizes of video would be extremely large. With the added sensors such as LIDAR, GPS, and various sources of information from the vehicle's available sensors, the storage memory capacity can be impossible to maintain. Therefore, an interactive, connected communication system is necessary and that can be utilized for date storage and analysis at a data center or server elsewhere.

### SUMMARY OF THE INVENTION

The telematics data storage architecture is created to serve as the melting pot for all data collection to take place on the road. For years, digital mapping companies have spent millions of dollars on casting and maintaining their digital assets. The present invention is comprised of several steps to achieve the intended goal of the near real-time depiction of a given region that would include all-natural and man-made elements that can be processed and indexed for multiple uses. The first process that will be discussed is the gathering of the required data.

1. Data Collection Equipment

The issues related to obtaining near real-time data that can be useful have always been a challenge. Data needs to be collected, stored, and processed repeatedly and on time for it to be up to date and serve a useful purpose. The present invention aims to solve this and other issues that prevent data from expiring or too old for accurate use. The discussion would have to focus on newer systems that are being developed that would allow the seamless transfer of data to be transmitted electronically to an infrastructure that would process the data based on time and location.

As discussed in the prior art, there are many of dash cameras deployed in vehicles today and their popularity is rising at an astounding rate. The installed devices can record locally the everyday occurrences that happen on the road as well as all of the background data that is inadvertently collected. Many of these systems are not equipped with any radio transceiver, whether Wi-Fi or cellular, and removing the data would require removing the memory unit or chip and inserting it into a computer connected to the internet. This is very impractical and would not work for the mass collection of data that is needed for a project of this scale. These systems would also need to have GPS radio so that an accurate time and location of the data collected can be established and indexed by the system. U.S. patent application Ser. No. 17/083,453 filed on Oct. 29, 2020 (the teachings of which necessary for the understanding of the present invention being incorporated herein) and entitled “Universal Telematics and Storage Devise for Vehicle-Based Camera Systems” provides a solution to this issue. With this achievement, data could now be collected from existing drive cameras already installed and in active use today. This additional hardware could be purchased or given to the user with an agreement to share the data that is collected. The systems, regardless of age or capability, could be turned into valuable data collection tools white still serving their intended purpose. Regardless of the camera used, position, or how many cameras are installed, the data could be collected with the exact GPS location and time that will be stamped on the image data that can later be indexed by remote servers or system.

These new systems provide a complete 360-degree total view from the camera or camera's perspective. The system captures an unprecedented complete 360-degree horizontally and over 180-degree vertical view of both the exterior areas and interior occupants of the vehicle as well as a complete view of the surrounding areas to include structural and environmental data. The system is equipped to record images locally on a memory storage device and also can be uploaded the information to any computer or cloud system either after the fact upon user's demand or in real-time utilizing a dedicated cellular or Wi-Fi transceiver signal connection. The system is compact and all of the required systems are located internally within the camera or in some cases a rearview mirror housing that would provide a perfect eye level mounting area for the optical 360 degree camera or suitable optics. The rear-view mirror housing would be equipped with an internal display that can display the captured images in real-time to assist the driver.

The event images and audio will be saved locally to the device and uploaded to any cellular, computer system, or the cloud. Both existing and newly installed systems would be equipped with a Wi-Fi transceiver that can determine and establish a remote encrypted wireless connection for the transfer of files recorded when a signal is received from a home base, warehouse, or other central location for automatic file transfer. The system utilizes GPS technology for accurate time, speed, and location of events reordered as well as recorded standard driving and background images. The systems are set up to send both encrypted and standard files based on security requirements. The system has the ability to view all recorded images and audio at any given time simultaneously for full situational awareness of the entire surrounding during a trip or drive. Both new and preinstalled systems gather information on roads, construction, infrastructure, and changes in them on a daily basis and is then sent to a secure server or to a secure Wi-Fi or internet connection.

2. Data Collection Process

The data collected from users with an agreement and an incentive program will be uploaded daily at a specific time or automatically with the vehicle sees and connects to a secure and encrypted Wi-Fi source such a home Wi-Fi system. Because in all cases the data is time-stamped and also has the exact GPS location, a virtual world, map, or an area including all structures, landscapes, and all objects are recorded daily. The data coming in from every user trip is encrypted and sent to a secure server that would use a blockchain arrangement to provide user anonymity and enhanced security ensuring the data usage is kept confidential. With many users contributing the data to the system an ever-evolving and maturing recreation of the area desired is obtained. Accuracy matures, or improves, as different angles of objects, roadways, traffic signals are accumulated and processed to form a virtual three-dimensional model of everything within the area. All changes to a road or bridge etc. . . . could be reflected in a very near real-time manner to assist in everything needed including data seat to autonomous vehicles that would benefit from the accurate and fresh information.

The data collection system focuses on the addition of blockchain technology to manage the vehicle originated data management architecture. The blockchain data system is fast, reliable and accessible while also ensuring complete privacy for both data originators and end-users. This architecture is accessible from a single user and large users, such as government agencies, digital mapping companies or vehicle manufacturers. By leveraging the power of decentralized blockchain technology, as well as other powerful network protocols, a new type of internet-based data, or digital map can be created.

Having all the data hosted on a blockchain can potentially improve latency significantly, as anybody with the internet-connected device can cross-reference information from your device and blockchain data, meaning significantly less information transmission as well as less processing.

Because of the verification systems used in decentralized ledgers, users can believe that these apps have accurate, up-to-date information that essentially cannot be tampered with. The fact that GPS signals can be altered by emitting faulty signals, leads to vehicle malfunctions and accidents creates a need for reliable, indelible and unalterable data. Because there is no central authority to process and publish the data, the entire system can move and respond toc hanging conditions in near real-time.

Due to the cryptographic nature of these networks, user information is kept private. There is no need to reveal your identity associated with the location to a massive corporation that then harvests your data. Users have full control of what parties or entities can see their info, and the entire system is completely transparent as to what is being shared. This eliminates the burden of location services being an open window into an individual's life.

The telematics unit in a vehicle utilizes cellular or Wi-Fi or any other transceiver in two-way communications to servers hosting the database managed by blockchain architecture, an operation that allows the unit to receive commands and index files needed as well as receiving both real-time and recorded data for instant analysis and sharing.

Blockchain technologies contain the following attributes:

Distributed and sustainable: The data ledger is shared, updated with every transaction, and selectively replicated among participants in near real-time. Because it is not owned or controlled by any single organization, the blockchain data platform is not dependent on any individual entity.

Secure, private, and indelible: Permission and cryptography prevent unauthorized access to the data network and ensure that participants are legitimate. Confidentiality is maintained through cryptographic technology and a partitioning of data to give participants selective visibility into the data ledger, both transactions and identity of transacting identity are masked. Both time and location must be verified and the verified data be transparent for use by the public.

Transparent and auditable: Because participants in a transaction have access to the same records, they can validate the data and verify identities without the need for third-party intermediaries. All data is geocoded and time-stamped, organized, and can be verified in near real-time.

Consensus-based and transactional: All relevant data participants must agree that a transaction is valid. This is realized through the use of consensus algorithms. Each blockchain data network can establish the conditions under which data exchange can occur.

Orchestrated and flexible: Because the data exchange rules and contracts (executed based on one or more conditions), are built into the blockchain platform, the communication network can evolve as they mature supporting data exchange processes and activities.

Under the blockchain data system, everyone with the existing invested asset to be valued fairly, as more data added to the system, the more chance that users (vehicle operator/driver) will use it. A reward system could then be built into the blockchain algorithms. The hidden digital assets may be from a municipal database and can be added to the big pool of the blockchain data system. This may earn rewards back to the original asset holding party or contributing individuals. There may be gold diggers come to arise, those who would study missing portion of maps of data, utilizing reliable, authenticated data-collecting devices, to contribute for necessary data to be added to the system. According to the amount of data, in relationship with the data complexity, the ones who assist in the creation of the data get regarded. The more you drive, the more data can be collected, more chance of receiving awards.

Autonomous vehicles, under development are vehicles equipped with many sensors onboard for determining the vehicle speed, location, and surrounding objects, creating data rich in information and valuable. However, this information is typically not shared with others and underutilized as public data for ensuring the safety of vehicle drivers.

Now with blockchain technology, it possible to address all of these issues and create a fast, reliable global mapping system that also is completely private for contributors. By leveling the power of decentralized technology, as well as other powerful network protocols, a new type of internet-based map can be created. Having all the data hosted on a blockchain can improve latency significantly, as the system can cross-reference information from the user's device along with sensor and preexisting blockchained data, meaningless information transmission as well as spam information or duplicated data can be eliminated.

For better understanding of the present invention as well as other objects and further features thereof, reference is made to the following description which is to be read in conjunction with the accompanying drawing wherein:

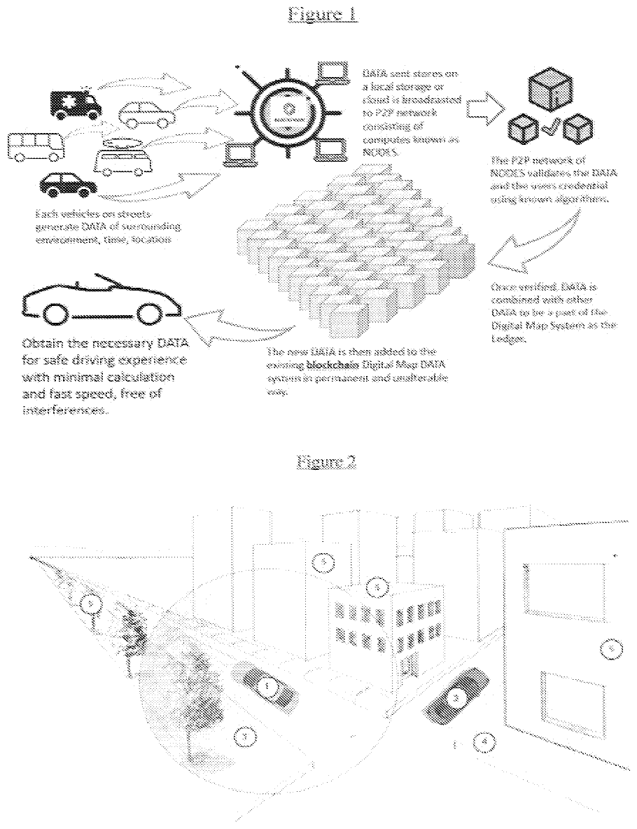

FIG. 1 is an overview of the blockchain system in use with the present invention;

FIG. 2 illustrates the perspective of vehicles equipped with 360-degree cameras in a city environment;

FIG. 3 is an illustration of the camera perspective of vehicles moving past an object being able to record multiple views;

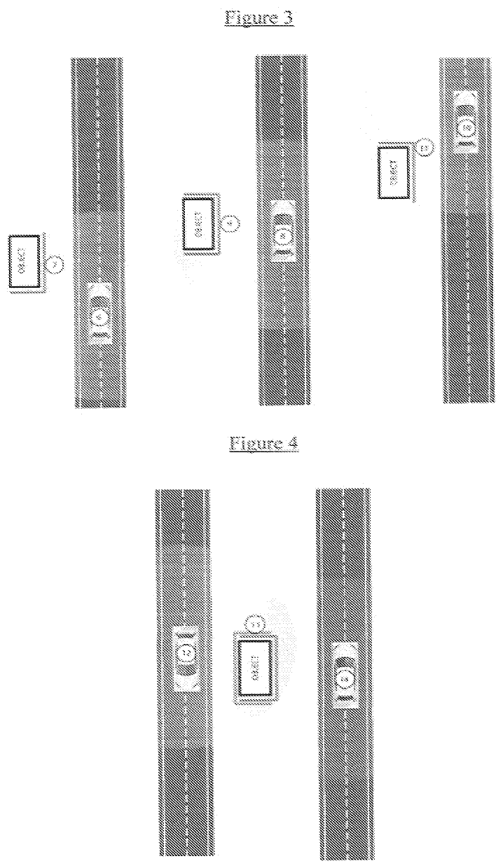

FIG. 4 is an illustration of how objects are recorded and processed to complete a true third-dimensional image;

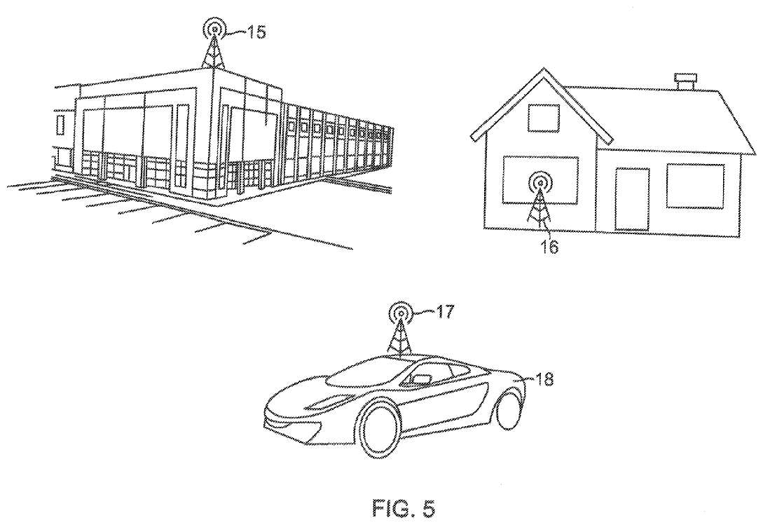

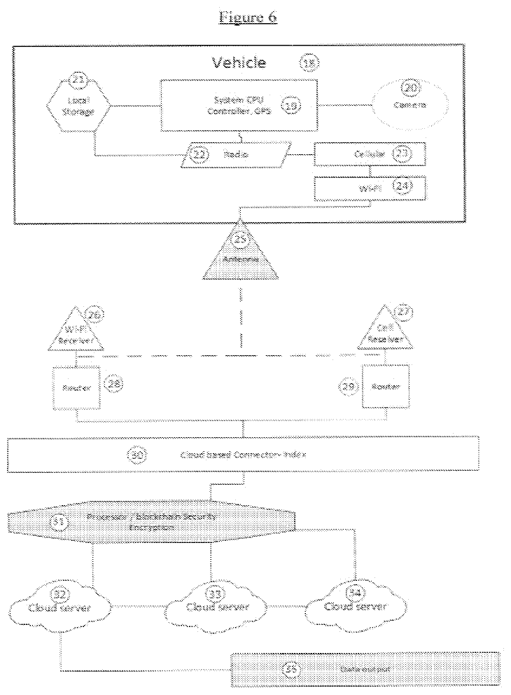

FIG. 5 is an illustration of the data transfer process utilizing cellular and Wi-Fi communication;

FIG. 6 is a block diagram of the process of transferring data from an enrolled vehicle to the blockchain cloud; and

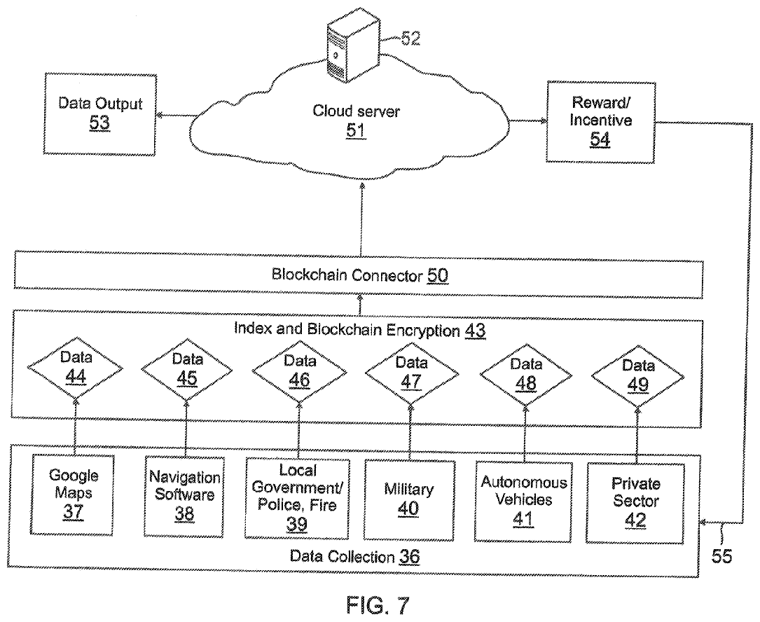

FIG. 7 is a block diagram of the data processing and blockchain systems.

### DESCRIPTION OF THE INVENTION

FIG. 1 is a simplified illustration of the blockchain system used with the present invention. In particular, the processes involved in turning raw images into a near real-time depiction of a geographical area including all structures and environmental components while securing the data and the privacy of the contributors is shown.

FIG. 2 is a description of a typical cityscape and the views of the city that can be provided by a three hundred sixty-degree camera. Regardless of the properties of the camera, recording angles, or the number of cameras fitted to the vehicle, the results would be the same but may require more information to update the image. As vehicle (1) is driving on an everyday task, the images recorded (3) are processed based on their geographical position using GPS and assisted by cellular triangulation. A second vehicle (2) does the same and records the images (4) of the surrounding areas (5) contained within the view of its camera. As more vehicles drive in the same vicinity, the images from their systems will be indexed by location and added to the images from all others that have been in that area. In this way, the image is “maturing” and becoming more accurate, the real-time changes would then be visible to the end-user if so desired.

FIG. 3 illustrates the image recording and processing of a 360-degree camera. Specifically, a vehicle equipped with this type of system captures multiple images of the same object from different angles recording data of three sides of a structure that can be processed using the position registered by the GPS in the system. A vehicle (6) is illustrated as approaching an object (or building) (7). As it approach the object (7), the vehicle camera has a clear image of the side facing the vehicle as well as the front of the object. A vehicle (8) now approaches the object (7) and has a better view of the front of object (7) and the front and back thereof depending on the size of object (7). The vehicle (6) now continues to move forward and passes object (7) with the perspective changing again. At this point, the system now captures the rear of object (7). Thus, on a single pass, the system acquires sufficient information to render approximately 75% of object (7) into the database collected by multiple enrolled drive-by vehicles made in any time frame. In essence, the system functions as a 3D scanner of objects detected by cameras and various sensors.

FIG. 4 is similar to FIG. 3 but gives a better idea of how connected vehicles all gathering data from different directions, heights, points of view will all contribute to the maturing of an image based on the position the image was filmed or recorded. Two enrolled vehicles (12) and (14) are illustrated as traveling on a highway in opposite directions. Using the method discussed to FIG. 3, the images of the object (13) are recorded as the vehicles approach, are parallel to and pass by the object (13) while recording the data based on GPS of where the images were recorded. One side of the object (13) is recorded by vehicle (12) and stored in the blockchain data. The other side of the object (13) is being recorded by vehicle (14) thus completing the image on all sides within the blockchain database. This process will repeat countless times maturing the image with every added data point. In this way, an entire city, for example, can be mapped together with other sources (for example, satellite, aircraft captured images or data) all and naturally occurring items that may updated constantly and reflect any changes that may have occurred based on forward-moving time.

FIG. 5 is an illustration of how the data is removed from the vehicle and added to the blockchain database structure. There are currently two ways the information can be retrieved from the vehicle, the first being Wi-Fi. When a vehicle (18) containing a camera system, GPS, and local storage returns to a home or office after a drive its Wi-Fi transceiver tries to connect with a known Wi-Fi network. These networks are secured with encryption but are password protected allowing easy access to the files or data that have been collected throughout the journey. Vehicle (18) with a Wi-Fi transceiver and antenna connects to a known and secure Wi-Fi network such as a home or office network (16) and then routed to a secure server to be indexed and added to the blockchain-based data collection system. This could happen periodically or automatically when the vehicle becomes in the range of the dedicated Wi-Fi network. When done daily the data collected would be in near real-time and fresh so the data would be very recent. The other way of receiving the data is via the cellular network. The vehicle (18) containing a camera, GPS, and a cellular transceiver (17) could automatically upload the data in real-time to the cellular network (15) on a constant or timed basis. This data could then be processed and used immediately if needed for the most accurate rendition or mapping of the infrastructure and environmental items within the desired area.

FIG. 6 is an illustration of the process for transferring data from the vehicle (18) to the blockchain encrypted servers. The camera processor or CPU (19) is connected to the camera system (20) that can be of any specification, such as a 360-degree camera, single front-facing camera, or multiple cameras equipped within the vehicle (18). The system is equipped with a local storage unit (21) that can be any storage medium and which holds the data locally until an outside connection is made via radio (22). Radio (22) contains both a Wi-Fi (24) and cellular transceiver (23) as well as supported antennas for both (25). Components (19), (20), (21), (22), (23), (24), and (25) are all contained within the vehicle (18). The cellular transceiver (23) can always be an operation when the vehicle is in use or be set to transmit at any given set time. The Wi-Fi transceiver (24) is always on standby until it detects the known network that it is paired with for a secure connection at the home or workplace or the user. Once connected via the antenna system (25), the signal or data is transmitted. In the case of Wi-Fi, the signal is sent by the vehicle through the Wi-Fi transceiver (24) through the antenna system (25) to the dedicated and secured Wi-Fi receiver (26) at the user's home or office. The data is then sent to a router that will transmit the data to a known server location within the connector (30) where it will be indexed by location and time. The first index point will be the location of the data first received. In the same manner, the cellular signals will be transmitted from the cellular transceiver (23) through the antenna system (25) to any available cellular receiver (27) and routed to the secure server through the systems router (29) and will be indexed in the connector (30). The cloud-based connector (30) will process and index the data and deliver it to the encrypted blockchain processor (31) where it will be stored, processed, and sent to the cloud server(s), (32), (33), and (34). These servers can be in a central area or be in various locations anywhere needed. The data will be stored securely until needed by a party and delivered in a secure manner to data output (35) whereat the data is encrypted and secured using a blockchain encryption method ensuring the integrity of the data.

FIG. 7 is an illustration of the blockchain process and the collection and distribution of the data. The video data can be collected from many entities that participate in the mapping program described hereinabove. Vehicles equipped with the camera system could all collect data for various projects and to help enable a low-cost system to aid in autonomous vehicle development and operations. The data collected by the systems in (36) can be comprised of many contributors such as Google® mapping (37), navigation software companies (38), local governments that can include data from police and emergency vehicle (39), the military (40), all forms of current autonomous vehicles (41) as well as the private sector (42). These entities could all be part of the data collection apparatus (36). The data is kept individually and is sent to be indexed and encrypted in the blockchain connector (43). Once the individual data is collected from the various contributors, (44), (45), (46), (47), (48), and (49) it is processed based on location data and time, the location data being the key for the indexing. The information or data is added to the blockchain and sent to the blockchain connector (43). The second data point after location will be time and date. The data is verified by the index of the same location at a different but similar time validating the shared data. All of the data is encrypted to ensure the data has not been compromised, does not expose the contributors, and does not lead to any privacy issues that may occur. After the verification, encryption, and processing of the data it is indexed based on the GPS location and sent to the blockchain connector (50). From there the data is routed to secure cloud servers (51) and (52) where it is securely stored and can no longer be altered. The data may mature as different data points are contributed from different angles and perspective points that will eventually be indexed. The data can be sent to various persons or companies in the data output (53). Once the data has been processed and added to the blockchain, it can only be accessed by secure users that have been granted the rights for the processed data.

While the invention has been described with reference to its preferred embodiment, it will be understood by those skilled in the art that various changes may be made and equivalents may be substituted for elements there of without departing from the true spirit and scope or the invention. In addition, many modifications may be made to adapt a particular situation or material to the teachings of the invention without departing from its essential teachings.

What is claimed:

1. A method for the collection, processing, and dissemination of vehicle data and images, said method comprising:
using a first 360-degree video camera mounted on a first moving vehicle traveling within a geographic vicinity, simultaneously collecting real-time video data of vehicle occupants and the geographic vicinity as captured by the first 360-degree video camera;
using a second 360-degree video camera mounted on a second moving vehicle, simultaneously collecting real-time video data of vehicle occupants and the geographic vicinity as captured by the second 360-degree video camera;
storing the video data captured by the first and second 360-degree video cameras in a blockchain database; and
disseminating information associated with the geographic vicinity using the video data captured by the first and second 360-degree video cameras.

2. The method according to claim 1, wherein the video data captured by the first and second 360-degree video cameras is time stamped.

3. The method according to claim 1, wherein the video data captured by the first and second 360-degree video cameras comprises GPS location data.

4. The method according to claim 1, wherein the first and second moving vehicles travel within the vicinity at different points in time, such that the first and second 360-degree video cameras collect video data of the vicinity at different points in time.

5. The method according to claim 4, and comprising displaying a maturing of the vicinity from a first point in time to a later second point in time using the video data captured by the first and second 360-degree video cameras.
